(19) United States
(12) Patent Application Publication
(10) Pub. No.: US 2018/0180269 A1
(43) Pub. Date: Jun. 28, 2018

(54) LAMP BASE

(71) Applicant: SHENZHEN ENVISION TECHNOLOGY LIMITED, Shenzhen, Guangdong (CN)

(72) Inventor: Yiquan LIU, Shenzhen, Guangdong (CN)

(73) Assignee: SHENZHEN ENVISION TECHNOLOGY LIMITED, Shenzhen, Guangdong (CN)

(21) Appl. No.: 15/311,738

(22) PCT Filed: Sep. 30, 2016
(86) PCT No.: PCT/CN2016/101177

§ 371 Date: Nov. 16, 2016

(30) Foreign Application Priority Data
Sep. 5, 2016 (CN) 201610802271.8

(51) Int. Cl. F21V 21/30; F21V 21/02

(52) U.S. Cl. CPC F21V 21/30; F21V 21/02

(57) ABSTRACT

The present invention discloses a lamp base, comprising a permanent seat and a lamp holder, wherein the permanent seat is formed with a receiving groove; the inner wall surface of the receiving groove is formed with an annular slide along the horizontal direction; the slide is internally provided with a slider; the lamp holder comprises rotating shafts; and the rotating shafts are rotationally connected to the slider. According to the present invention, adjustment on the light-emitting angle can be completed by simply rotating the lamp holder. The use is convenient and the operation is easy. Moreover, the lamp holder is disposed in the receiving groove, which greatly reduces the overall size of the lamp base; meanwhile, the lamp base only comprises two parts, namely the lamp holder and the permanent seat, which greatly simplifies the structure and brings convenience in maintenance.

### TECHNICAL FIELD

The present invention relates to the field of lighting devices, in particular to a lamp base.

### DESCRIPTION OF RELATED ART

Along with increasing demands on the development of industrial technologies, the lighting effects of lamps have become more and more diversified. In some special circumstances, lighting in a single direction cannot meet the demands of users. The majority of existing lamp bases are of rigid installation, and cannot be adjusted in angle, failing to meet the multi-range radiation demands of lamps, lacking flexibility and leaving limits in lamp installation planning on the market. Therefore, some angle-adjustable lamp bases are available on the market for adjusting the light-emitting angle of the lamps, but such lamp bases have defects.

A patent document, with an application No. 2011101513.6, discloses a lamp base. The lamp base comprises a fixing device, a movable device and a connecting rod; the connecting rod is connected between the fixing device and the movable device, and the length of the connecting rod is adjusted to control the light-emitting angle of the lamp on the fixing device. The lamp base can effectively change the light-emitting angle of the lamp, but has a lot of parts and components and has a complicated structure, and after the adjustment on the connecting rod, the connecting rod needs to be locked with a lock, so the operation is relatively complicated.

A patent document, with an application No. 201210506964.4, discloses a structure with a lamp adapter capable of being adjusted manually and a lamp, which is actually another lamp base structure. The lamp base comprises a turntable and a support disposed on the turntable; the support is rotationally connected with the lamp adapter for adjusting the pitch lighting angle of the lamp adapter; when the turntable rotates, the support also rotates for adjusting the horizontal lighting angle of the lamp adapter. The lamp base of such structure has a large size, and some parts of the turntable have relatively high fault rates.

### BRIEF SUMMARY OF THE INVENTION

The technical problem to be solved in the present invention is to provide a lamp base which has a simple structure and a small size and is convenient in use.

To solve the above mentioned technical problems, the present invention adopts the technical solution of providing a lamp base which comprises a permanent seat and a lamp holder.

The permanent seat is formed with a receiving groove; the inner wall surface of the receiving groove is formed with an annular slide along the horizontal direction; and the slide is internally provided with a slider.

The lamp holder includes rotating shafts. The rotating shafts are rotationally connected to the slider.

The present invention has the beneficial effects that: the lamp base of the present invention includes the permanent seat and the lamp holder; the permanent seat is formed with the receiving groove and the inner wall surface of the receiving groove is formed with the slide; the lamp holder is rotationally connected to the slider in the slide through the rotating shafts. For the lamp base with such structure, the lamp holder is rotationally connected to the inside of the slide, so the lamp base can undergo adjustment on the pitch lighting angle. Besides, the slide is an annular slide formed along the horizontal direction. Therefore, the lamp holder can undergo omni-bearing adjustment in the horizontal direction to change the horizontal light-emitting angle of the lamp adapter on the lamp holder. According to the present invention, the adjustment on the light-emitting angle can be completed by simply rotating the lamp holder. The use is convenient and the operation is easy. Moreover, compared with the prior art, the lamp holder of the present invention is disposed in the receiving groove, which greatly reduces the overall size of the lamp base; meanwhile, the lamp base only includes two parts, namely the lamp holder and the permanent seat, which greatly simplifies the structure and brings convenience in maintenance.

### BRIEF DESCRIPTION OF THE SEVERAL VIEWS OF THE DRAWINGS

FIG. 1 is a structural exploded view of a permanent seat and a lamp holder of a lamp base according to an embodiment of the present invention.

FIG. 2 is a structural view of the permanent seat, with a slider removed, of the lamp base according to an embodiment of the present invention.

FIG. 3 is a structural exploded view of the lamp base structure according to an embodiment of the present invention.

FIG. 4 is an enlarged view of part B in FIG. 3.

### DESCRIPTION OF MARKS

Permanent seat—1;

receiving groove—11;

first bottom plate—12;

first side wall plate—13;

slider—14;

mounting groove—141;

limiting groove—142;

surface housing—15;

bottom housing—16;

fixing column—17;

first screw hole—18;

flange—19;

lamp holder—2;

accommodating groove—21;

second bottom plate—22;

second side wall plate—23;

rotating shaft—24;

limiting projection—241;

extension portion—25;

connecting base—26;

lamp adapter—3;

reinforcing rib—5;

slide—5.

### DETAILED DESCRIPTION OF THE INVENTION

The key concept of the present invention lies in that the lamp base of the present invention includes a permanent seat 1 and a lamp holder 2; the permanent seat 1 is formed with a receiving groove 11 and the inner wall surface of the receiving groove 11 is formed with a slide 5; and, the lamp holder 2 is rotationally connected to the inside of the slide 5 through rotating shafts 24. The present invention can effectively reduce the size of the lamp base, and is convenient in use and simple in structure.

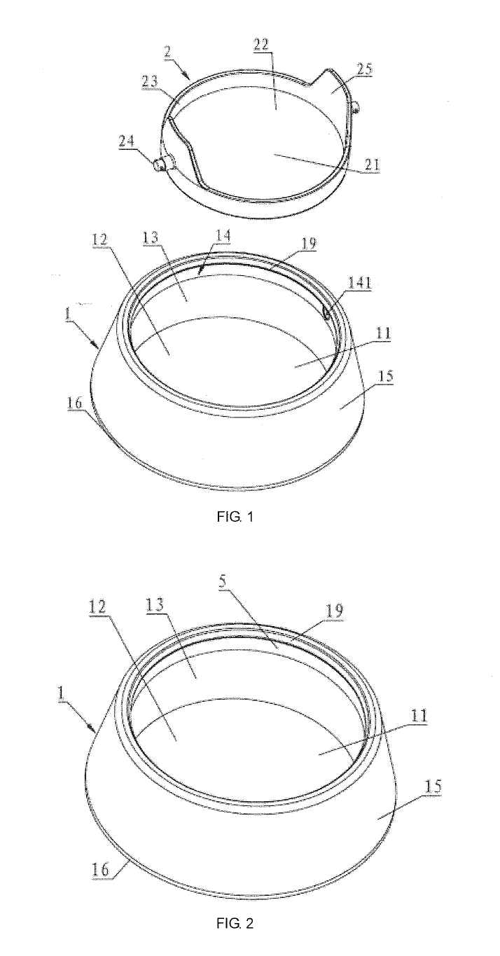

Refer to FIG. 1 and FIG. 2. The lamp base of the present invention includes the permanent seat 1 and the lamp holder 2.

The permanent seat 1 is formed with the receiving groove 11; the inner wall surface of the receiving groove 11 is formed with the annular slide 5 along the horizontal direction; and the slide 5 is internally provided with a slider 14.

The lamp holder 2 includes rotating shafts 24. The rotating shafts 24 are rotationally connected to the slider 14.

From the above description it can be known that, the present invention has the beneficial effects of: the lamp base of the present invention includes the permanent seat 1 and the lamp holder 2; the permanent seat 1 is formed with the receiving groove 11 and the inner wall surface of the receiving groove 11 is formed with the slide 5; and, the lamp holder 2 is rotationally connected to the slider 14 in the slide 5 through the rotating shafts 24. For the lamp base with such structure, the lamp holder 2 is rotationally connected to the inside of the slide 5, so the lamp base 2 can undergo adjustment on the pitch lighting angle. Besides, the slide 5 is an annular slide 5 formed along the horizontal direction. Therefore, the lamp holder 2 can undergo omni-bearing adjustment in the horizontal direction to change the horizontal light-emitting angle of a lamp adapter 3 of the lamp holder 2. According to the present invention, the adjustment on the light-emitting angle can be completed by simply rotating the lamp holder 2. The use is convenient and the operation is easy. Moreover, compared with the prior art, the lamp holder 2 of the present invention is disposed in the receiving groove 11, which greatly reduces the overall size of the lamp base; meanwhile, the lamp base only includes two parts, namely the lamp holder 2 and the permanent seat 1, which greatly simplifies the structure and brings convenience in maintenance.

From the above description it can be known that, by setting the slider 14, the slider 14 slides relative to the slide 5 to protect the rotating shafts 24 effectively, capable of preventing the rotating shafts 24 from wearing and ensuring the stability when the lamp holder 2 undergoes pitch adjustment relative to the permanent seat 1.

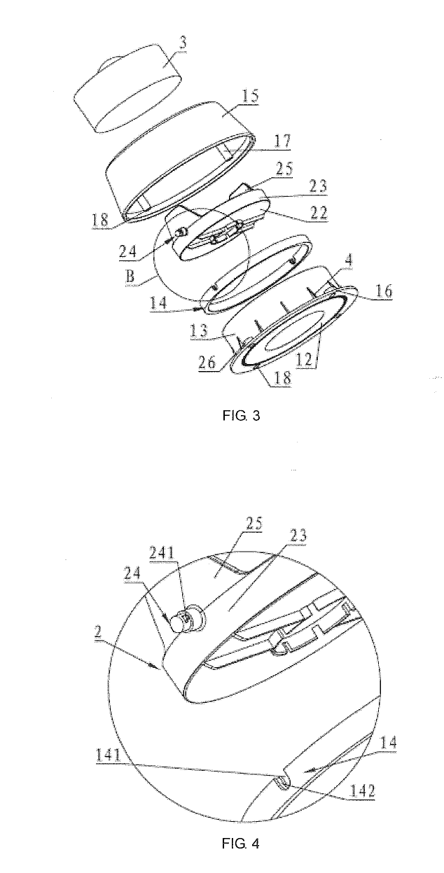

Further, refer to FIG. 3 and FIG. 4 together. The slider 14 is formed with mounting grooves 141; limiting grooves 142 are disposed on the end faces on two sides of each of the mounting grooves 141; each of the rotating shafts 24 is provided with a limiting projection 241; each of the rotating shafts 24 is installed in a corresponding one of the mounting grooves 141 and each of the limiting projections 241 is limited in a corresponding one of the limiting groove 142.

As shown in FIG. 4, in this embodiment, each of the mounting grooves 141 is U-shaped, and the opposite end faces on the inner side of each of the mounting grooves 141 are formed with the limiting grooves 142. The limiting grooves 142 extend from the opening of the mounting grooves 141 to the bottom. After the rotating shafts 24 are installed at the mounting grooves 141, the limiting projections 241 are limited in the limiting grooves 142. With the arrangement of such structure, it is possible that the limiting projections 241 separate from the limiting grooves 142 when the rotating shafts 24 rotate. At this moment, the lamp holder 2 reaches the maximum adjustable pitch angle. In addition, by arranging the limiting projections 241 and the limiting grooves 142, the rotating shafts 24 can be effectively prevented from separating from the mounting grooves 141 along the axial direction.

Further, the slide 5 is round, and the slide 5 is a circle without interruption.

As shown in FIG. 1 and FIG. 2, the permanent seat 1 is shaped as a cone, and the limiting grooves 142 are round. The limiting grooves 142 are formed at the small end of the cone. The slide 5 is disposed at the tops of the limiting grooves 142. The round slide 5 can widen the horizontal adjusting angle of the lamp holder 2.

Further, the permanent seat 1 includes a surface housing 15 and a bottom housing 16.

The bottom housing 16 includes a first bottom plate 12 and a first side wall plate 13 which is vertically disposed along the circumference of the first bottom plate 12. The first bottom plate 12 and the first side wall plate 13 form the receiving groove 11. The surface housing 15 is disposed in a way of covering the bottom housing 16.

As shown in the figure, the surface housing 15 has a shape similar to a reducing pipe, including a large end and a small end. The bottom housing 16 is installed at the large end.

Further, the surface housing 15 is internally provided with fixing columns 17; the first bottom plate 12 is provided with a connecting base 26; the connecting base 26 is provided with recesses; the recesses are matched with the fixing columns 17 such that the fixing columns 17 are clamped in the recesses. By using the clamping structure, the bottom housing 16 is conveniently assembled with the surface housing 15.

Further, each of the fixing columns 17 is internally provided with a first screw hole 18; each of the recesses is provided with a second screw hole; the fixing columns 17 are clamped in the recesses, and screws pass the first screw holes 18 and the second screw holes to connect the surface housing 15 and the bottom housing 16.

From the above description it can be known that, the surface housing 15 and the bottom housing 16 are assembled with the clamping structure. In this way, during the process of installing the surface housing 15 at the bottom housing 16, the pre-positioning is simpler, and in the subsequent screw connection process, the surface housing 15 and the bottom housing 16 are prevented from relative sliding, improving the assembling efficiency.

Further, reinforcing ribs 4 are disposed at the joint of the first bottom plate 12 and the first side wall plate 13. The reinforcing ribs 4 can effectively improve the overall strength.

Further, a flange 19 is disposed in an inward folding way at the upper end of the surface housing; a gap is formed between the upper end of the bottom housing and the lower end of the flange 19; and the gap forms the slide 5.

The slide 5 is jointly formed by the surface housing and the bottom housing. The annular slider is disposed in the gap in a sliding manner. The slider can be taken down after the bottom housing and the surface housing are removed. Of course, in other embodiments, the slide 5 can also be disposed on the inner wall surface of the first side wall plate of the bottom housing directly.

Further, the lamp holder 2 includes a second bottom plate 22 and a second side wall plate 23; the second bottom plate 22 and the second side wall plate 23 surround an accommodating groove 21; and the rotating shafts 24 are symmetrically disposed on two sides of the accommodating groove 21.

As shown in the Figure, the accommodating groove 21 is used for placing the lamp adapter 3, and the shape of the accommodating groove 21 is matched with the lamp adapter 3.

Further, extension portions 25 for being held by hands are disposed at the upper end face of the second side wall plate 23.

The extension portions 25 are disposed for the main purpose of applying forces. When the lamp holder 2 rotates, by pushing or pulling the force applying portions, the lamp holder 2 can rotate relative to the permanent seat 1, and by toggling the extension portions 25, the pitch angle of the lamp holder 2 is conveniently adjusted.

Refer to FIGS. 1-4. Embodiment 1 of the present invention is as follows. A lamp base of the embodiment 1 includes a permanent seat 1 and a lamp holder 2; the permanent seat 1 is shaped as a cone; the upper part of the cone is formed with a receiving groove 11; the lamp base 2 has a shape matched with the receiving groove 11; the lamp base 2 is equipped with a lamp adapter 3; the lamp adapter 3 equipped at the lamp base 2 can undergo the pitch angle adjustment and can undergo horizontal angle adjustment along the horizontal direction.

The permanent seat 1 includes a surface housing 15 and a bottom housing 16. The bottom housing 16 includes a first bottom plate 12 and a first side wall plate 13 which is vertically disposed along the circumference of the first bottom plate 12. The first bottom plate 12 and the first side wall plate 13 form the receiving groove 11. On the outer side of the receiving groove 11, reinforcing ribs 4 for reinforcing the structure are disposed at the joint of the first bottom plate 12 and the first side wall plate 13.

The surface housing 15 has a shape similar to a reducing pipe, including a large end and a small end. The surface housing 15 is internally provided with fixing columns 17. The lower end of each of the fixing columns 17 extends to the large end. Each of the fixing columns 17 is internally provided with a first screw hole 18. The first bottom plate 12 is provided with a connecting base 26. The connecting base 26 is provided with recesses. Each of the recesses is provided with a second screw hole. The recesses are matched with the fixing columns 17. During installation, the fixing columns 17 are clamped in the recesses, and screws pass the first screw holes 18 and the second screw holes to connect the surface housing 15 and the bottom housing 16.

A flange 19 is disposed in an inward folding way at the upper end of the surface housing; a gap is formed between the upper end of the bottom housing and the lower end of the flange 19; and the gap forms the slide 5. The slide 5 is internally provided with a slider 14 in a sliding manner.

The lamp holder 2 includes a second bottom plate 22 and a second side wall plate 23; the second bottom plate 22 and the second side wall plate 23 surround an accommodating groove 21; and the rotating shafts 24 are symmetrically disposed on two sides of the accommodating groove 21. Extension portions 25 for being held by hands are disposed at the upper end face of the second side wall plate 23.

The slider 14 is formed with mounting grooves 141; limiting grooves 142 are disposed on end faces on two sides of each of the mounting grooves 141; the rotating shafts 24 are provided with limiting projections 241; the rotating shafts 24 are installed in the mounting grooves 141 and the limiting projections 241 are limited in the limiting grooves 142.

In conclusion, the lamp base provided by the present invention is simple in structure and convenient in use and maintenance, the size is greatly reduced, and the assembling efficiency is high.

Technical Problems

Solution

Beneficial Effects of the Present Invention

1. A lamp base, characterized by comprising a permanent seat and a lamp holder, wherein the permanent seat is formed with a receiving groove; the inner wall surface of the receiving groove is formed with an annular slide along the horizontal direction; the slide is internally provided with a slider; the lamp holder comprises rotating shafts; and the rotating shafts are rotationally connected to the slider.

2. The lamp base according to claim 1, wherein the slider is formed with mounting grooves; limiting grooves are disposed at the end faces on two sides of the mounting grooves; each of the rotating shafts is provided with a limiting projection; each of the rotating shafts is installed in a corresponding one of the mounting grooves and each limiting projection is limited in a corresponding one of the limiting grooves.

3. The lamp base according to claim 1, wherein the slide is round, and the slide is a circle without interruption.

4. The lamp base according to claim 1, wherein the permanent seat comprises a surface housing and a bottom housing; the bottom housing comprises a first bottom plate and a first side wall plate which is vertically disposed along the circumference of the first bottom plate; the first bottom plate and the first side wall plate form the receiving groove; and the surface housing is disposed in a way of covering the bottom housing.

5. The lamp base according to claim 4, wherein the surface housing is internally provided with fixing columns; the first bottom plate is provided with a connecting base; the connecting base is provided with recesses; and the recesses are matched with the fixing columns such that the fixing columns are clamped in the recesses.

6. The lamp base according to claim 5, wherein each of the fixing columns is internally provided with a first screw hole; each of the recesses is provided with a second screw hole; the fixing columns are clamped in the recesses, and screws pass the first screw holes and the second screw holes to connect the surface housing and the bottom housing.

7. The lamp base according to claim 4, wherein a flange is disposed in an inward folding way at the upper end of the surface housing; a gap is formed between the upper end of the bottom housing and the lower end of the flange; and the gap forms the slide.

8. The lamp base according to claim 1, wherein the permanent seat is shaped as a cone.

9. The lamp base according to claim 1, wherein the lamp holder comprises a second bottom plate and a second side wall plate; the second bottom plate and the second side wall plate surround an accommodating groove; and the rotating shafts are symmetrically disposed on two sides of the accommodating groove.

10. The lamp base according to claim 9, wherein extension portions for being held by hands are disposed at the upper end face of the second side wall plate.

11. The lamp base according to claim 5, wherein a flange is disposed in an inward folding way at the upper end of the surface housing; a gap is formed between the upper end of the bottom housing and the lower end of the flange; and the gap forms the slide.

12. The lamp base according to claim 6, wherein a flange is disposed in an inward folding way at the upper end of the surface housing; a gap is formed between the upper end of the bottom housing and the lower end of the flange; and the gap forms the slide.
